(19) United States
(12) Patent Application Publication
(10) Pub. No.: US 2009/0162075 A1
(43) Pub. Date: Jun. 25, 2009

(54) Transmission system and transmission method

(75) Inventor: Kanji NAITO, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/230,246

(22) Filed: Aug. 26, 2008

(30) Foreign Application Priority Data
Dec. 21, 2007 (JP) 2007-330730

(51) Int. Cl. H04B 10/04

(52) U.S. Cl. 398/182

(57) ABSTRACT

A transmission system includes a transmission device that performs data communication with adjacent transmission devices. The transmission device calculates the error rates of data communication, and set line cost based on the error rate. The transmission device synchronizes obtained line costs, and learn the line cost of each line between the transmission devices. The transmission device selects a path with the lowest line cost and perform data transmission through the path.

### CROSS-REFERENCE TO RELATED APPLICATIONS

This application is based upon and claims the benefit of priority of the prior Japanese Patent Application No. 2007-330730, filed on Dec. 21, 2007, the entire contents of which are incorporated herein by reference.

### BACKGROUND

1. Field

The present invention relates to a transmission system and a transmission method.

2. Background

The recent widespread use of optical networks has enabled transmission of a large volume of data at high speed. A plurality of transmission devices present in an optical network each select an optimal path from among a plurality of paths to transmit data to a destination.

Specifically, when a plurality of paths are present between transmission devices, the transmission devices select a path for transmitting data based on costs set for transmission devices by a manager. The manager manually sets a cost for each path by monitoring a line capacity, a transmission delay, and a line quality between the transmission devices.

Japanese Patent Application Laid-open No. 2004-208289 discloses a conventional technology in which an aggregate point node in a multi-cast transfer is selected based on topology information and delay information in a data transmission.

In the conventional technology, however, a manager manually sets a cost for each path by monitoring changes in state (e.g., line capacity, transmission delay, and line quality) between transmission devices. Therefore, the cost cannot be set depending on the state of the path that constantly changes over time, and the transmission devices cannot select an optimal path.

Thus, there is a need for a technology to set a cost depending on the state of a path that constantly changes over time and select an optimal path.

### SUMMARY

It is an object of the present invention to at least partially solve the problems in the conventional technology.

According to an aspect of an embodiment, there is provided a transmission system that determines a path-for data transmission based on line cost set for each line between transmission devices, including an error calculating unit that calculates an error rate of data communicated between the transmission devices; and a first determining unit that determines first line cost for each line between the transmission devices based on the error rate obtained by the error calculating unit.

According to another aspect of an embodiment, there is provided a transmission system that determines a path for data transmission based on line cost set for each line between transmission devices, including a time calculating unit that calculates time taken for data transmitted from each of the transmission devices to reach a destination; and a first determining unit that determines first line cost for each line between the transmission devices based on the time obtained by the time calculating unit.

According to still another aspect of an embodiment, there is provided a transmission method applied to a transmission system that determines a path for data transmission based on line cost set for each line between transmission devices, including calculating an error rate of data communicated between the transmission devices; storing the error rate in the storage device; and determining first line cost for each line between the transmission devices based on the error rate stored in the storage device.

According to still another aspect of an embodiment, there is provided a transmission method applied to a transmission system that determines a path for data transmission based on line cost set for each line between transmission devices, including calculating time taken for data transmitted from each of the transmission devices to reach a destination; storing the time in the storage device; and determining first line cost for each line between the transmission devices based on the time stored in the storage device.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating the outline and features of a transmission system according to a first embodiment of the present invention;

FIG. 2 is a block diagram of a transmission device shown in FIG. 1;

FIG. 3 is an example of the data structure of a main signal generated by an OH inserting unit shown in FIG. 2;

FIG. 4 is an example of the data structure of an error rate/cost management table according to the first embodiment;

FIG. 5 is an example of the data structure of a line cost management table according to the first embodiment;

FIG. 6 is an example of the data structure of a line connection database shown in FIG. 2;

FIG. 7 is a flowchart of the operation of the transmission device shown in FIG. 1;

FIG. 8 is a schematic diagram illustrating the outline and features of a transmission system according to a second embodiment of the present invention;

FIG. 9 is a block diagram of a transmission device shown in FIG. 8;

FIG. 10 is an example of the data structure of a multi-frame generated by an OH inserting unit shown in FIG. 9;

FIG. 11 is an example of the data structure of an arrival time/cost management table according to the second embodiment;

FIG. 12 is an example of the data structure of a line cost management table according to the second embodiment;

FIG. 13 is an example of the data structure of a line connection database shown in FIG. 9;

FIG. 14 is a flowchart of the operation of the transmission system shown in FIG. 8;

FIG. 15 is a block diagram of a transmission device according to a third embodiment of the present invention;

FIG. 16 is an example of the data structure of a first line cost management table according to the third embodiment;

FIG. 17 is an example of the data structure of a second line cost management table according to the third embodiment;

FIG. 18 is an example of the data structure of a signal used-by the transmission device shown in FIG. 15 to synchronize line costs; and

FIG. 19 is an example of the data structure of a line connection database shown in FIG. 15.

### DETAILED DESCRIPTION OF THE PREFERRED EMBODIMENTS

Exemplary embodiments are explained in detail below with reference to the accompanying drawings.

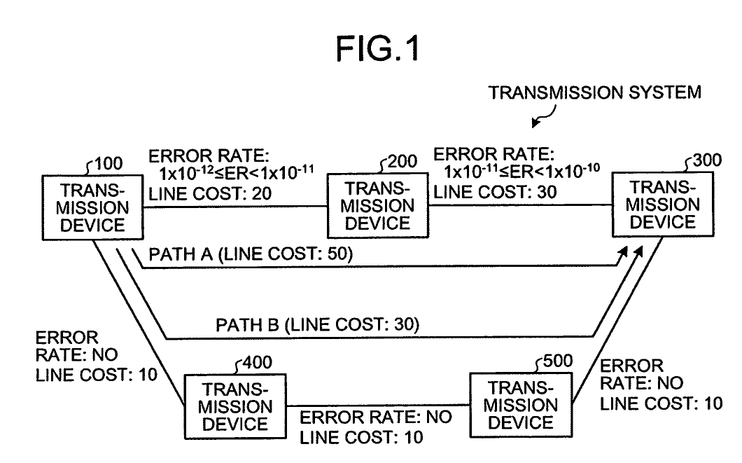

Described below is the outline and configuration of a transmission system according to a first embodiment. FIG. 1 is a schematic diagram illustrating the outline and features of the transmission system according to the first embodiment. As shown in FIG. 1, the transmission system includes transmission devices 100 to 500. Each of the transmission devices 100 to 500 performs data communication with adjacent transmission devices regularly (or irregularly) and calculates an error rate to set line cost between the transmission devices based on the error rate. According to the first embodiment, the larger the error rate is, the larger the line cost is set.

In the example of FIG. 1, the error rate (ER) of data communicated between the transmission device 100 and the transmission device 200 is 1×10⁻¹¹≦ER<1×10⁻¹¹, and the line cost is set at 20. The error rate of data transmitted between the transmission device 200 and the transmission device 300 is 1×10⁻¹¹≦ER<1×10⁻, and the line cost is set at 30.

When error does not occur in data transmitted between the transmission device 100 and a transmission device 400, between the transmission device 400 and the transmission device 500, and between the transmission device 500 and the transmission device 300 (alternatively, when the error rates are less than a threshold), the line costs are set at 10 as the basic line cost.

For example, as the paths for transmitting data from the transmission device 100 to the transmission device 300, there are path A that reaches the transmission device 300 through the transmission device 200, and path B that reaches the transmission device 300 through the transmission devices 400 and 500.

In this case, the transmission device 100 calculates the line costs of path A and path B, and selects as the transmission path the one with a smaller line cost than that of the other. In the example of FIG. 1, the line cost of path A (the total line cost included in path A) is 50, and the line cost of path B (the total line cost included in path B) is 30. Therefore, the transmission device 100 transmits data to the transmission device 300 through path B with line cost smaller than that of path A.

As described above, in the transmission system according to the first embodiment, each of the transmission devices 100 to 500 performs data communication with adjacent transmission devices, calculates error rates, and sets line costs based on the calculated error rates. Thus, it is possible to set line cost depending on the state of a path that constantly changes over time and select an optimal path as well as to reduce the burden on a manager.

The configuration of the transmission devices 100 to 500 is described below. The transmission devices 100 to 500 are of like configuration and thus but one of them, the transmission device 100, is explained in detail.

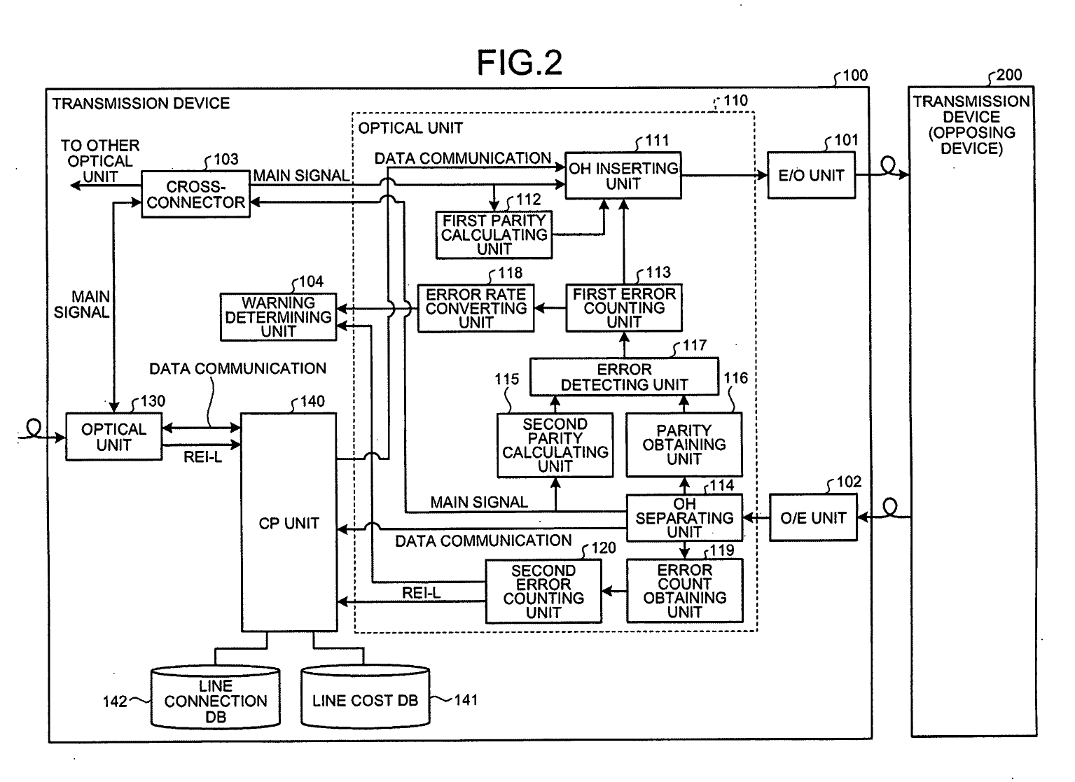

FIG. 2 is a block diagram of the transmission device 100. As shown in FIG. 2, the transmission device 100 includes an E/O unit 101, an 0/E unit 102, a cross-connector 103, a warning determining unit 104, optical units 110 and 130, a control plane (CP) unit 140, a line cost database (DB) 141, and a line connection DB 142. Although only two optical units, the optical units 110 and 130, are-shown for convenience of illustration, the transmission device 100 may include more optical units.

The E/O unit 101 converts an electric signal input from the optical unit 110 into an optical signal that is then output to an opposing device (the transmission device 200). The O/E unit 102 converts an optical signal input from the opposing device into an electric signal that is then output to the optical unit 110.

The-cross-connector 103 outputs main signals input from the optical units 110 and 130 to an optical unit that is a destination specified in advance. For example, the cross-connector 103 outputs a main signal input from the optical unit 130 to the optical unit 110. The warning determining unit 104 obtains an error rate from the optical unit 110, and when the obtained error rate is equal to or larger than a threshold, issues a warning by an output device such as a monitor or a speaker (not shown).

The optical units 110 and 130 generate various types of information related to error rate calculation. The optical units 110 and 130 (other optical unit) are of basically the same configuration and operate in the same manner, and thus only the optical unit 110 is described below.

As shown in FIG. 2, the optical unit 110 includes an OH inserting unit 111, a first parity calculating unit 112, a first error counting unit 113, an OH separating unit 114, a second parity calculating unit 115, a parity obtaining unit 116, an error detecting unit 117, and an error rate converting unit 118.

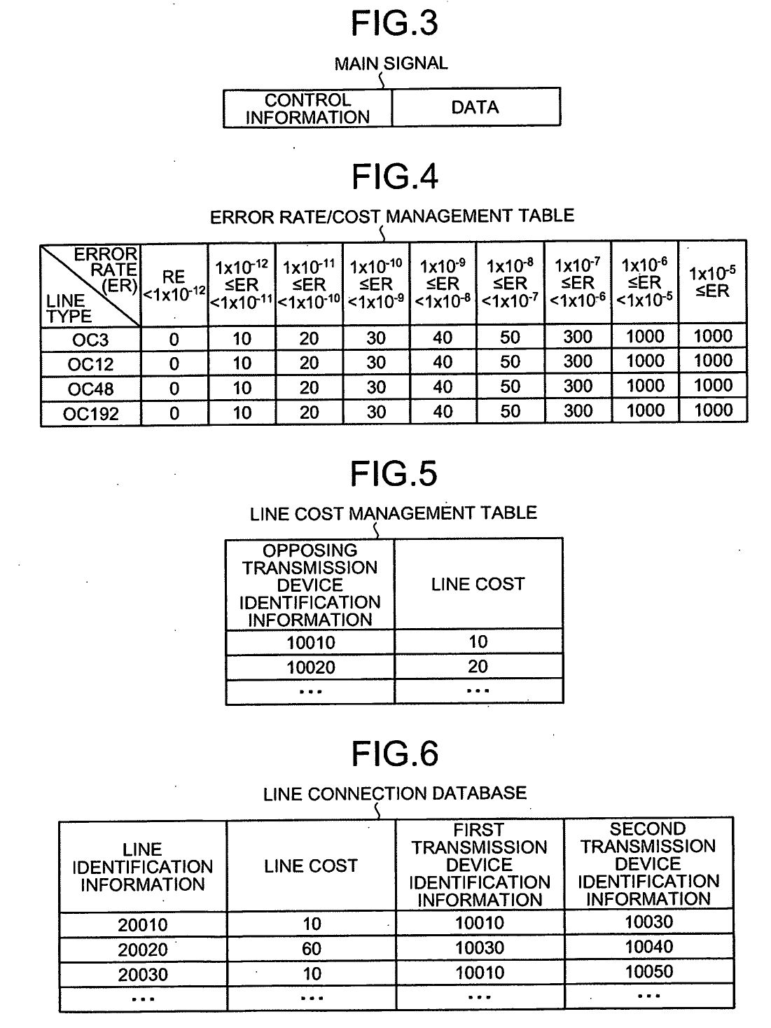

Upon receiving a main signal from the cross-connector 103, the OH inserting unit 111 inserts parity obtained from the first parity calculating unit 112 and the number of errors or an error count obtained from the first error counting unit 113 to a region of control information included in the main signal (position of B2 byte, position of M1 byte or M0 byte and M1 byte that are over head byte). FIG. 3 is an example of the data structure of a main signal generated by the OH inserting unit 111. The OH inserting unit 111 outputs the generated main signal to the E/O unit 101.

The first parity calculating unit 112 calculates the parity based on the data region of the main signal output from the cross-connector 103. The first parity calculating unit 112 outputs the parity that is the calculation result to the OH inserting unit 111.

The first error counting unit 113 obtains the error count from the error detecting unit 117, and counts errors for every second. The first error counting unit 113 outputs the error count to the OH inserting unit 111 and the error rate converting unit 118.

The OH separating unit 114 obtains electric signal from the O/E unit 102, and obtains a main signal and control information from the obtained electric signal (over head byte: M1 byte or M0 byte and M1 byte). The OH separating unit 114 outputs the obtained main signal to the second parity calculating unit 115 and the cross-connector 103, and outputs the control information to the parity obtaining unit 116 and an error count obtaining unit 119.

Upon receiving the main signal from the OH separating unit 114, the second parity calculating unit 115 calculates the parity based on the data region of the main signal. The second parity calculating unit 115 outputs the calculated parity to the error detecting unit 117.

Upon receiving the control information from the OH separating unit 114, the parity obtaining unit 116 obtains the parity included in the control information. The parity obtaining unit 116 outputs the obtained parity to the error detecting unit 117.

The error detecting unit 117 detects an error by comparing parity obtained from the parity obtaining unit 116 (hereinafter, “first parity”), and parity obtained from the second parity calculating unit 115 (hereinafter, “second parity”).

Specifically, when the first parity and the second parity are different from each other, the error detecting unit 117 outputs the error count that is the number of different values to the first error counting unit 113. For example, when the first parity is “1100”, and the second parity is “1111”, the parities are different in two values, and therefore the error count “2” is output to the first error counting unit 113. When the first parity and the second party are the same with each other, the error detecting unit 117 does not output any error count, or alternatively outputs zero as the error count.

Upon receiving the error count from the first error counting unit 113, the error rate converting unit 118 calculates the error rate. The error rate indicates the number of errors in data transmitted per second, and can be calculated as, for example, follows:

error rate=error count(the number of errors)/the total number of data items

The error rate converting unit 118 outputs the calculated error rate to the warning determining unit 104.

Upon receiving the control information from the OH separating unit 114, the error count obtaining unit 119 obtains the error count included in the control information. The error count obtaining unit 119 outputs the obtained error count to the second error counting unit 120.

The second error counting unit 120 obtains the error count from the error count obtaining unit 119, counts errors for every second, and calculates the error rate based on the error count. The second error counting unit 120 calculates the error rate in a manner similar to that of the error rate converting unit 118. The second error counting unit 120 outputs the calculated error rate to the warning determining unit 104 and the CP unit 140.

The CP unit 140 performs various processing related to data transmission, and determines line cost based on the error rate. For example, when the error rate is high in data communication with the transmission device 200, the CP unit 140 automatically increases the line cost between the transmission device 100 and the transmission device 200.

As shown in FIG. 2, the CP unit 140 is connected to the line cost DB 141 and the line connection DB 142. The line cost DB 141 stores therein an error rate/cost management table for determining the line costs, and a line cost management table for managing the line costs among adjacent transmission devices.

FIG. 4 is an example of the data structure of the error rate/cost management table. As shown in FIG. 4, the error rate/cost management table shows the line costs of error rates depending on various line types (OC3, OC12, OC48, OC192). For example, when the line type is “OC3”, and the error rate is 1×10⁻¹¹≦ER<1×10⁻¹⁰, the line cost is “20”. It is assumed that the line types between transmission devices are set in advance.

The line cost set for between the transmission devices is the sum of the line costs obtained from the error rate/cost management table and the standard cost set in advance by a manager. Specifically, when the line type between the transmission device 100 and the transmission device 200 is “OC3”, the error rate is “1×10⁻¹¹≦ER<1×10⁻¹⁰”, and the standard cost is “10”, the CP unit 140 sets the line cost between the transmission device 100 and the transmission device 200 at “30”, and registers this line cost in the line cost management table explained below.

FIG. 5 is an example of the data structure of the line cost management table according to the first embodiment. As shown in FIG. 5, the line cost management table contains opposing transmission device identification information and line cost. The opposing transmission device identification information identifies a transmission device connected thereto as the other party of communication. For example, a piece of opposing transmission device identification information of the transmission device 100 identifies the transmission device 200.

In the example of FIG. 5, the line cost of the path from the transmission device 100 to a transmission device having opposing transmission device identification information “10010” is set to “10”, and the line cost of the path from the transmission device 100 to a transmission device having opposing transmission device identification information “10020” is set to “20”.

The CP unit 140 transmits to the transmission devices 200 to 500 information for identifying the transmission device 100 and the information registered in the line cost management table in association with each other. At the same time, the CP unit 140 obtains information in which the line cost management table (the line cost management table stored in each of the transmission devices 200 to 500) and information for identifying the transmission device are associated with each other from the transmission devices 200 to 500, thereby synchronizing line costs between the transmission devices. For example, the CP unit 140 synchronizes line costs between the transmission devices using a technique known as open shortest path first-traffic engineering (OSPF-TE).

The line connection DB 142 stores therein information on line costs among the transmission devices. The information stored in the line connection DB 142 is updated every time the above synchronization is performed. FIG. 6 is an example of the data structure of the line connection DB 142. As shown in FIG. 6, the line connection DB 142 stores therein line identification information, line cost, first transmission device identification information, and second transmission device identification information.

The line identification information identifies each line (communication path) between transmission devices. The line cost indicates the cost of a line identified by the line identification information. The first transmission device identification information and the second transmission device identification information identify transmission devices at both ends of a line identified by the line identification information. For example, when the line identified by the line identification information “20010” connects between the transmission devices 100 and 200, the first transmission device identification information identifies the transmission device 100, and the second transmission device identification information identifies the transmission device 200.

When transmitting data to a destination, the CP unit 140 extracts a plurality of paths to the destination referring to the line connection DB 142. The CP unit 140 calculates the line costs of the extracted paths, and selects one of the paths with the lowest line cost to transmit the data to the destination through the selected path (see FIG. 1).

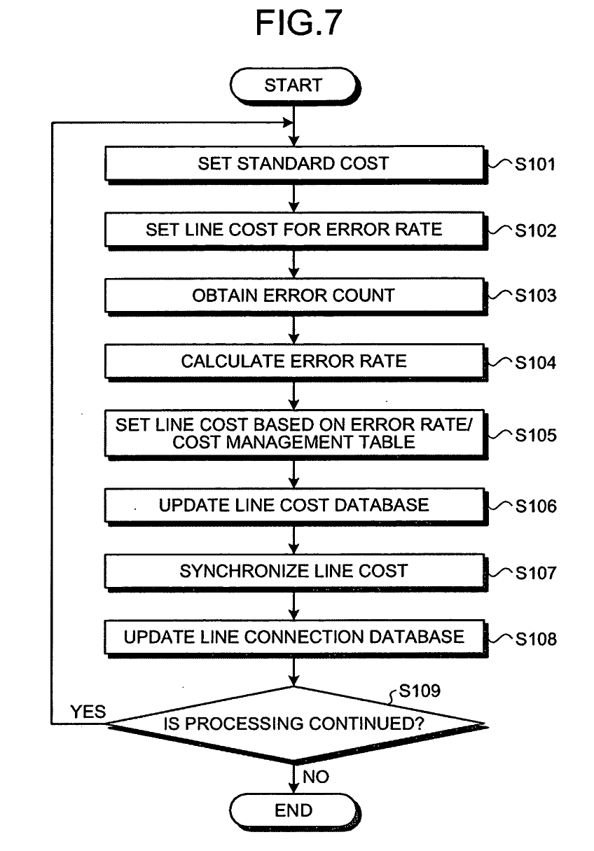

The operation of the transmission device 100 is described below. FIG. 7 is a flowchart of the operation of the transmission device 100. As shown in FIG. 7, the transmission device 100 sets the standard cost (receives the standard cost set by the manager) (step S101), and sets the line cost for the error rate (step S102).

Upon receiving data from the opposing device, the transmission device 100 obtains the error count included in the control information of the received data (step S103), and calculates the error rate (step S104).

Then, the transmission device 100 sets the line cost based on the error rate/cost management table (step S105), and updates the line cost management table stored in the line cost DB 141 (step S106).

Then, the transmission device 100 synchronizes the line cost (step S107), and updates the line connection DB 142 (step S108). If the transmission device 100 continues the processing (YES at step S109), the processing returns to the step S101, and if not (NO at step S109), the processing is terminated.

In this manner, the transmission device 100 calculates an error rate in data exchange with the transmission device 200, i.e., an opposing device, and sets the line cost based on the error rate. Therefore, the cost among the transmission devices can be set accurately.

As described above, in the transmission system according to the first embodiment, each of the transmission devices 100 to 500 performs data communication with adjacent transmission devices, calculates the error rate, and sets the line cost based on the calculated error rate. Therefore, it is possible to set the line cost depending on the state of a path that constantly changes over time and select an optimal path as well as to reduce the burden on the manager.

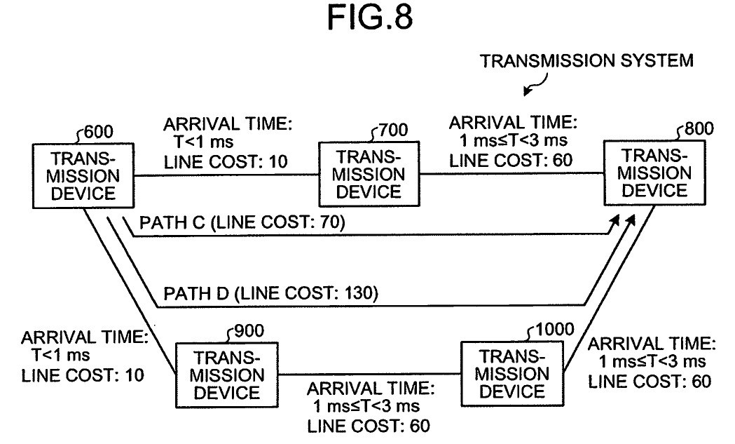

Described below is the outline and features of a transmission system according to a second embodiment. FIG. 8 is a schematic diagram illustrating the outline and features of the transmission system according to the second embodiment. As shown in FIG. 8, the transmission system includes transmission devices 600 to 1000. Each of the transmission devices 600 to 1000 performs data communication with adjacent transmission devices, calculates the time taken for data transmitted from the transmission device to reach each of the adjacent transmission devices (hereinafter, “arrival time”), and sets line cost between the transmission devices based on the arrival time.

In the example of FIG. 8, arrival time T of data transmitted between the transmission device 600 and the transmission device 700 is T<1 ms, and the line cost is set at 10. The arrival time T of data transmitted between the transmission device 700 and the transmission device 800 is 1 ms≦T<3 ms, and the line cost is set at 60. The arrival time T of data transmitted between the transmission device 600 and a transmission device 900 is T<1 ms, and the line cost is set at 10.

The arrival time T of data transmitted between the transmission device 900 and a transmission device 1000 is 1 ms≦T<3 ms, and the line cost is set at 60. The arrival time T of data transmitted between the transmission device 1000 and a transmission device 800 is 1 ms≦T<3 ms, and the line cost is set at 60.

As the path for transmitting data from the transmission device 600 to the transmission device 800, there are path C that reaches the transmission device 800 through the transmission device 700, and path D that reaches the transmission device 800 through the transmission devices 900 and 1000.

In this case, the transmission device 600 calculates the line cost of path C and the line cost of path D, and selects as the transmission path of data the one with a smaller line cost than that of the other. In the example shown in FIG. 8, the line cost of path C (the total line cost included in path C) is 70, and the line cost of path D (the total line cost included in path D) is 130. Therefore, the transmission device 600 transmits data to the transmission device 800 through path C with the line cost smaller than that of path D.

As described above, in the transmission system according to the second embodiment, each of the transmission devices 600 to 1000 performs data communication with adjacent transmission devices, calculates arrival time, and sets line cost based on the calculated arrival time. Therefore, it is possible to set line cost depending on the state of a path that constantly changes over time and select an optimal path as well as to reduce the burden on a manager.

In the transmission system according to the second embodiment, a transmission device of a transmission source adds information about a transmission time to a multi-frame that is obtained by connecting a plurality of frames and treated as one signal of J0 byte that is used as a test signal in a connection by a link management protocol (LMP), and another transmission device as an opposing device that has received the multi-frame determines arrival time on a transmission path based on the transmission time added to the multi-frame, and the device's time information.

The opposing device then adds the arrival time to the multi-frame, and returns the multi-frame to the transmission device of the transmission source. The transmission device that has received the multi-frame increases and decreases the line cost based on the arrival time added to the multi-frame.

The configuration of the transmission devices 600 to 1000 is described below. The transmission devices 600 to 1000 are of like configuration and thus but one of them, the transmission device 600, is explained in detail.

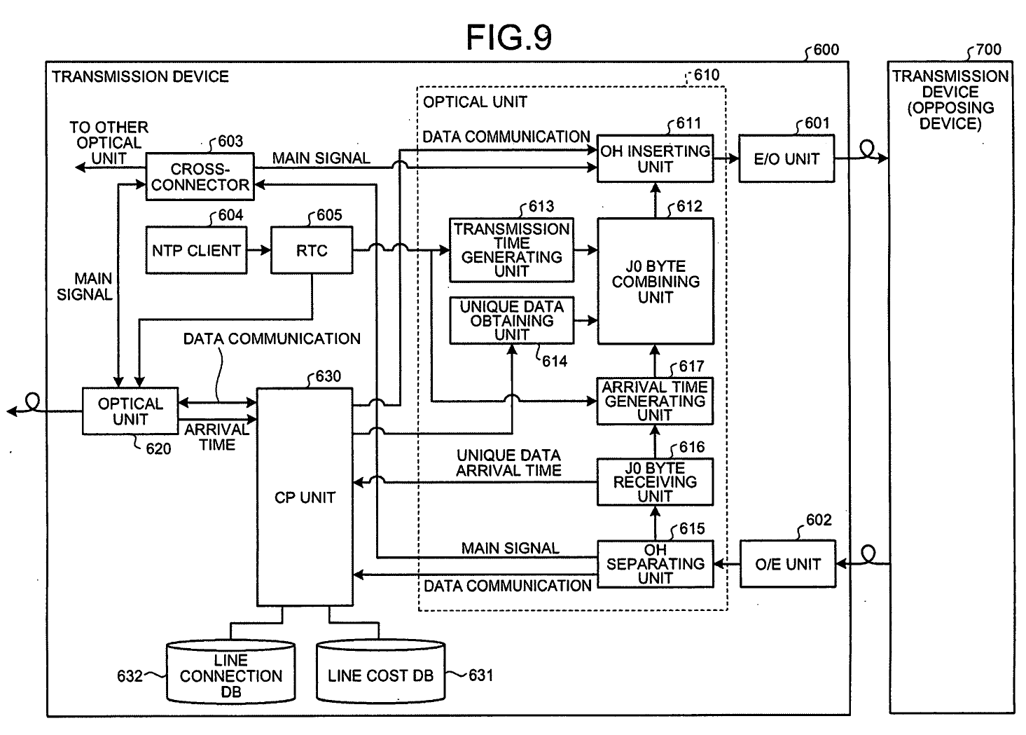

FIG. 9 is a block diagram of the transmission device 600. As shown in FIG. 9, the transmission device 600 includes an E/O unit 601, an O/E unit 602, a cross-connector 603, a network time protocol (NTP) client 604, a real time clock (RTC) 605, optical units 610 and 620, a CP unit 630, a line cost DB 631, and a line connection DB 632. For the convenience of explanation, only the optical units 610 and 620 are shown, but the transmission device 600 may have other optical units.

The E/O unit 601 converts an electric signal input from the-optical unit 610 to an optical signal, and outputs the converted optical signal to a transmission device 700 that is an opposing device. The O/E unit 602 converts an optical signal input from opposing device 700 to an electric-signal, and outputs the converted electric signal to the optical unit 610.

The cross-connector 603 outputs main signals input from the optical units 610 and 620 to an optical unit that is a destination specified in advance. For example, the cross-connector 603 outputs a main signal input from the optical unit 620 to the optical unit 610.

The NTP client 604 performs data communication with the other transmission devices 700 to 1000, and synchronizes a clock time of the RTC 605 with RTCs of the other transmission devices 700 to 1000. The RTC 605 outputs clock time information to the optical units 610 and 620 (or the other optical units).

The optical units 610 and 620 generate various information about arrival time. The optical units 610 and 620 are of basically the same configuration and operate in the same manner, and thus only the optical unit 610 is described below.

As shown in FIG. 9, the optical unit 610 includes an OH inserting unit 611, a J0 byte combining unit 612, a transmission time generating unit 613, a unique data obtaining unit 614, an OH separating unit 615, a J0 byte receiving unit 616, and an arrival time generating unit 617.

Upon receiving a main signal from the cross-connector 603, the OH inserting unit 611 generates a multi-frame to which various data obtained from the J0 byte combining unit 612 (unique data, transmission time, and arrival time) is added in a region of control information of the main signal (over head byte). The OH inserting unit 611 outputs the generated multi-frame to the E/O unit 601.

The unique data is unique to an interface set from outside of the system through CP unit 630, and does not overlap with other unique data. By referring to the unique data, it-becomes possible, for example, to identify a transmission device of a transmission source of a multi-frame, and the multi-frame.

A transmission time is information for identifying a clock time at which the transmission device 600 transmits a multi-frame. The term “arrival time” as used herein refer to the time required for data transmission between an opposing device (the transmission device 700 in FIG. 9) and the transmission device 600.

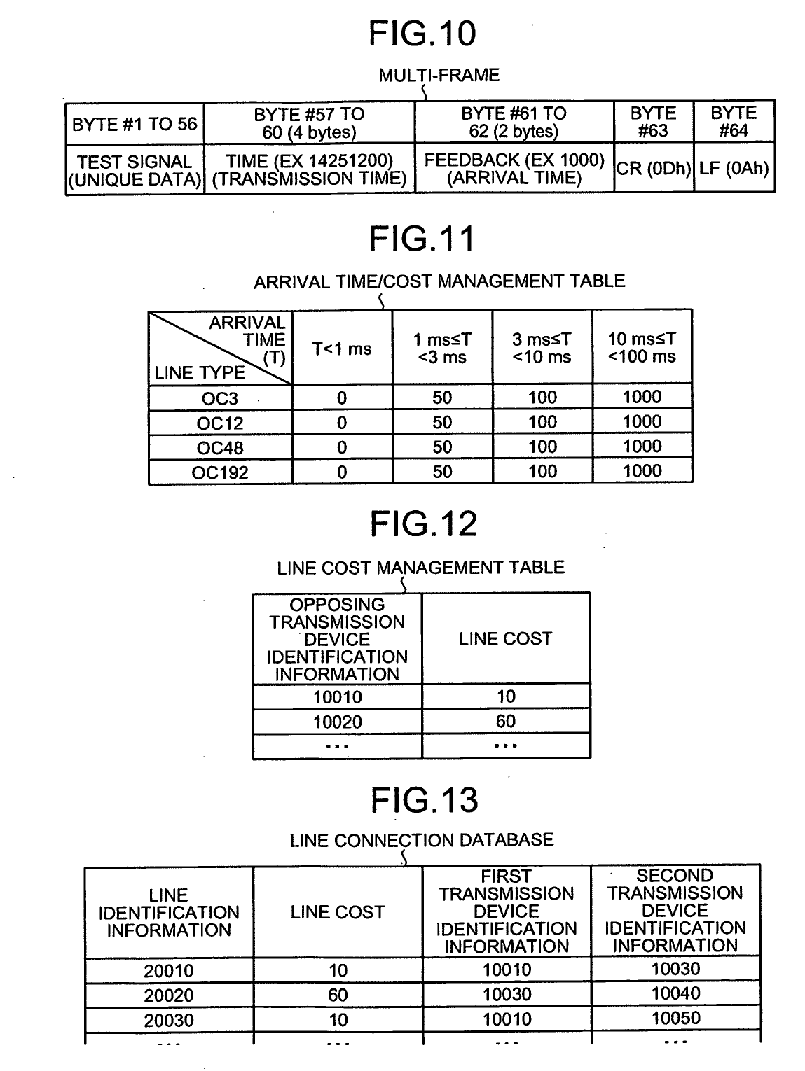

FIG. 10 is an example of the data structure of a multi-frame generated by the OH inserting unit 611. In the example of FIG. 10, unique data is stored at 1 to 56 byte, a transmission time is stored at 57 to 60 byte, arrival time is store at 61 to 62 byte, and end data of the multi-frame is stored at 63 to 64 byte.

The J0 byte combining unit 612 obtains a transmission time from the transmission time generating unit 613, unique data from the unique data obtaining unit 614, and arrival time from the arrival time generating unit 617, and outputs information of the obtained transmission time, the unique data, and the arrival time to the OH inserting unit 611.

The transmission time generating unit 613 generates information of the transmission time based on clock time information input from the RTC 605. The transmission time generating unit 613 outputs the information of the generated transmission time to the J0 byte combining unit 612. When the unique data obtaining unit 614 obtains the unique data from the CP unit 630, the unique data obtaining unit 614 outputs the obtained unique data to the J0 byte combining unit 612.

When the OH separating unit 615 obtains an electric signal from the O/E unit 602, the OH separating unit 615 obtains a main signal and control information (unique data, transmission time, and arrival time) included in the obtained electric signal. The OH separating unit 615 outputs the control information to the J0 byte receiving unit 616, and outputs the main signal to the cross-connector 603.

When the J0 byte receiving unit 616 obtains the control information from the OH separating unit 615, the J0 byte receiving unit 616 outputs the unique data and the arrival time included in the control information to the CP unit 630, and outputs the transmission time to the arrival time generating unit 617.

The arrival time generating unit 617 compares the clock time information obtained from the RTC 605 and the transmission time obtained from the J0 byte receiving unit 616, and thereby generates arrival time. The arrival time generating unit 617 outputs information of the generated arrival time to the J0 byte combining unit 612.

The CP unit 630 performs various processing related to data transmission, and sets line cost based on arrival time. For example, when the arrival time is long, the CP unit 630 automatically increases the line cost between the transmission device 600 and the transmission device 700.

As shown in FIG. 9, the CP unit 630 is connected to the line cost DB 631 and the line connection DB 632. The line cost DB 631 stores therein an arrival time/cost management table for determining line cost, and a line cost management table for managing line cost between adjacent transmission devices.

FIG. 11 is an example of the data structure of the arrival time/cost management table. As shown in FIG. 11, the arrival time/cost management table shows the line costs of arrival times corresponding to line types (OC3, OC12, OC48, and OC192). For example, when the line type is “OC3”, and the arrival time T is 1 ms≦T<3 ms, the line cost is “50”. It is assumed that the line types between transmission devices are set in advance.

The line cost set for between the transmission devices is the sum of the line costs obtained from the arrival time/cost management table and the standard cost set in advance by a manager. Specifically, when the line type between the transmission device 600 and the transmission device 700 is “OC3”, the arrival time T is 1 ms≦T<3 ms, and the standard cost is “10”, the CP unit 630 sets the line cost between the transmission device 600 and the transmission device 700 at “60”, and registers this line cost in the line cost management table explained below.

FIG. 12 is an example of the data structure of the line cost management table according to the second embodiment. As shown in FIG. 12, the line cost management table contains opposing transmission device identification information and line cost. The opposing transmission device identification information identifies a transmission device connected thereto as the other party of communication. For example, a piece of opposing transmission device identification information of the transmission device 600 identifies the transmission device 700.

In the example of FIG. 12, the line cost of the path from the transmission device 600 to a transmission device having opposing transmission device identification information “10010” is set to “10”, and the line cost of the path from the transmission device 600 to a transmission device having opposing transmission device identification information “10020” is set to “60”.

The CP unit 630 transmits to the transmission devices 700 to 1000 information for identifying the transmission device 600 and the information registered in the line cost management table in association with each other. At the same time, the CP unit 630 obtains information in which the line cost management table (the line cost management table stored in each of the transmission devices 700 to 1000) and information for identifying the transmission device are associated with each other from the transmission devices 700 to 1000, thereby synchronizing line costs between the transmission devices. For example, the CP unit 630 synchronizes line costs between the transmission devices using a technique known as OSPF-TE.

The line connection DB 632 stores therein information on line costs among the transmission devices. The information stored in the line connection DB 632 is updated every time the above synchronization is performed. FIG. 13 is an example of the data structure of the line connection DB 632. As shown in FIG. 13, the line connection DB 632 stores therein line identification information, line cost, first transmission device identification information, and second transmission device identification information.

The line identification information identifies each line (communication path) between transmission devices. The line cost indicates the cost of a line identified by the line identification information. The first transmission device identification information and the second transmission device identification information identify transmission devices at both ends of a line identified by the line identification information. For example, when the line identified by the line identification information “20010” connects between the transmission devices 600 and 700, the first transmission device identification information identifies the transmission device 600, and the second transmission device identification information identifies the transmission device 700.

When transmitting data to a destination, the CP unit 630 extracts a plurality of paths to the destination referring to the line connection DB 632. The CP unit 630 calculates the line costs of the extracted paths, and selects one of the paths with the lowest line cost to transmit the data to the destination through the selected path (see FIG. 8).

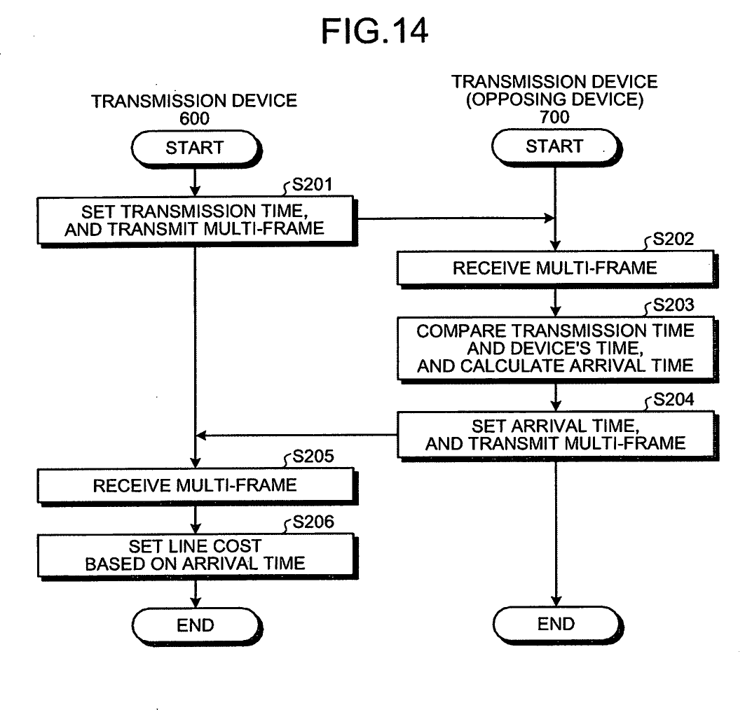

The operation of the transmission system according to the second embodiment is described below. FIG. 14 is a flowchart of the operation of the transmission system according to the second embodiment. In FIG. 14, the transmission device 600 and the transmission device 700 transmit and receive a multi-frame.

As shown in FIG. 14, the transmission device 600 sets transmission time and transmits a multi-frame to the transmission device 700 (step S201). The transmission device 700 receives the multi-frame (step 202).

The transmission device 700 compares the transmission time included in the multi-frame, and the device's time to calculate arrival time (step S203), and sets the arrival time to transmit the multi-frame to the transmission device 600 (step S204).

The transmission device 600 receives the multi-frame from the transmission device 700 (step S205), and obtains the arrival time included in the multi-frame to set line cost based on the arrival time (step S206).

In this manner, the transmission device 600 performs transmission of the multi-frame with the transmission device 700 that is an opposing device to calculate the arrival time, and sets the line cost based on the calculated arrival time, thereby enabling to set line cost between transmission devices accurately.

As described above, in the transmission system according to the second embodiment, each of the transmission devices 600 to 1000 performs transmission of a multi-frame with adjacent transmission devices, calculates arrival time, and sets line cost based on the arrival time. Therefore, it is possible to set the line cost depending on a state of a path that constantly changes over time and select an optimal path as well as reduce the burden on the manager.

Described below is the outline and features of a transmission system according to a third embodiment. In the transmission system according to the third embodiment, line cost is set in the same manner as previously described in the first and second embodiments. That is, line cost is calculated based on error rate, or based on arrival time.

Hereinafter, line cost calculated based on error rate is referred to as “first line cost”, and line cost calculated based on arrival time is referred to as “second line cost”.

A manager of the transmission system sets in advance either to use the first line cost, or to use the second line cost. Each transmission device selects an optimal path that has the lowest line cost based on a set line cost (the first line cost or the second line cost), and performs data transmission through the selected path.

The transmission system according to the third embodiment calculates the first line cost and the second line cost, and selects a path based on a line cost type set in advance. Therefore, the manager can select a path having a lower error rate or a path having a shorter arrival time for data transmission, and perform data transmission in a desired manner.

For example, a transmission device selects a path using the first line cost when transmitting data susceptible to an error, and not susceptible to a delay time. The transmission device selects a path using the second line cost when transmitting data resistant to an error, and susceptible to a delay time.

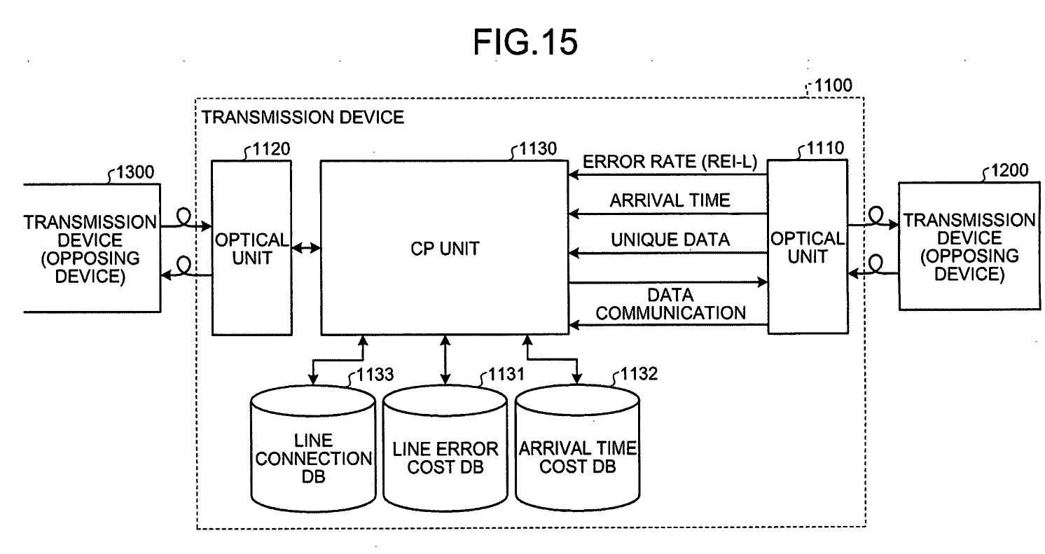

Described below is the configuration of the transmission device according to the third embodiment. FIG. 15 is a block diagram of a transmission device 1100 according to the third embodiment. As shown in FIG. 15, the transmission device 1100 includes optical units 1110 and 1120, a CP unit 1130, a line error cost DB 1131, an arrival time cost DB 1132, and a line connection DB 1133. The transmission device 1100 is connected to transmission devices 1200 and 1300 that are opposing devices through optical fibers or the like.

The optical units 1110 and 1120 generate various information related to calculation of an error rate and arrival time. An optical unit 1110 and the optical unit 1120 are of basically the same configuration and operate in the same manner, and only the former is explained.

The optical unit 1110 performs data communication with the transmission device 1200 as an opposing device, and calculates the error rate and arrival time.

The optical unit 1110 calculates an error rate in a manner similar to that of the optical unit 110 shown in FIG. 2. Specifically, when the optical unit 1110 transmits a main signal to the transmission device 1200 that is an opposing device, the optical unit 1110 performs processing corresponding to those of the OH inserting unit 111, the first parity calculating unit 112, and the first error counting unit 113, generates a main signal to which a parity obtained from the first parity calculating unit 112, and an error count obtained from the first error counting unit 113 are added, and transmits the main signal to the opposing device.

Upon receiving a main signal from an opposing device, the optical unit 1110 performs processing corresponding to those of the OH separating unit 114, the second parity calculating unit 115, the parity obtaining unit 116, the error detecting unit 117, the error count obtaining unit 119, and the second error counting unit 120, calculates an error rate, and outputs information about the error rate to the CP unit 1130.

The optical unit 1110 calculates arrival time in a manner similar to that of the optical unit 610 shown in FIG. 9. Specifically, when the optical unit-1110 transmits a main signal (multi-frame) to the transmission device 1200 that is an opposing device, the optical unit 1110 performs processing corresponding to those of the OH inserting unit 611, the J0 byte combining unit 612, the transmission time generating unit 613, the unique data obtaining unit 614, and the arrival time generating unit 617, generates a main signal to which unique data, a transmission time, and an arrival time are added, and transmits the main signal to the opposing device.

Upon receiving a main signal from an opposing device, the optical unit 1110 performs processing corresponding to those of the OH separating unit 615 and the J0 byte receiving unit 616, and outputs information about the unique data and the arrival time to the CP unit 1130.

The CP unit 1130 performs various processing related to data transmission, and sets line cost between transmission devices by calculating a first line cost based on error rate, and calculating a second line cost based on arrival time.

As shown in FIG. 15, the CP unit 1130 is connected to the line-error cost DB 1131, the arrival time cost DB 1132, and the line connection DB 1133. The line error cost DB 1131 stores therein an error rate/cost management table for determining a first line cost based on error rate, and a first line cost management table for managing a first line cost between adjacent transmission devices.

The error rate/cost management table is similar to that of the first embodiment shown in FIG. 4. Explaining with reference to FIG. 4, for example, when a line type is “OC3”, and an error rate is “1×10⁻¹¹≦ER<1×10⁻¹⁰”, the first line cost is “20”. It is assumed that the line types between transmission devices are set in advance.

The first line cost set for between the transmission devices is the sum of the line costs obtained from the error rate/cost management table and the standard cost set in advance by a manager. Specifically, when the line type between the transmission device 1100 and the transmission device 1200 is “OC3”, the error rate is “1×10⁻¹⁰≦ER<1×10⁻¹⁰”, and the standard cost is “10”, the CP unit 1130 sets the first line cost between the transmission device 1100 and the transmission device 1200 at “30”, and registers this line cost in the line cost management table explained below.

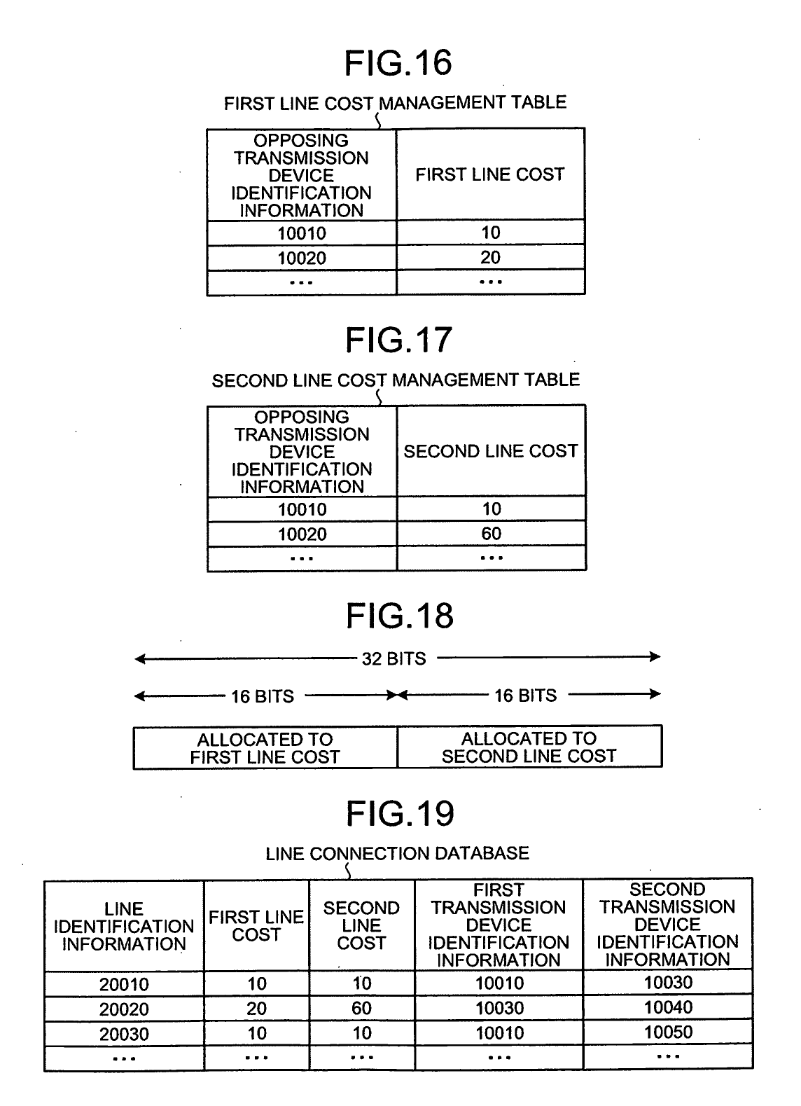

FIG. 16 is an example of the data structure of the first line cost management table. As shown in FIG. 16, the first line cost management table contains opposing transmission device identification information, and line costs. The opposing transmission device identification information identifies another transmission device connected opposing to a transmission device. For example, the opposing transmission device identification information of the transmission device 1100 identifies the transmission device 1200 and the transmission device 1300.

In the example of FIG. 16, the line cost of the path from the transmission device 1100 to a transmission device of the opposing transmission device identification information “10010”, is set at “10”, and the line cost of the path from the transmission device 1100 to a transmission device of the opposing transmission device identification information “10020”, is set at “20”.

The arrival time cost DB 1132 stores therein an arrival time/cost management table for determining the second line cost, and a second line cost management table for managing a second line cost between adjacent transmission devices.

The arrival time/cost management table is similar to that of the second embodiment shown in FIG. 11. Explaining with reference to FIG. 11, for example, when a line type is “OC3”, and an arrival time T is 1 ms≦T<3 ms, the second line cost is “50”. It is assumed that the line types between transmission devices are set in advance.

The second line cost set for between the transmission devices is the sum of the second line cost obtained from the arrival time/cost management table and the standard cost set in advance by a manager. Specifically, when the line type between the transmission device 1100 and the transmission device 1200 is “OC3”, the arrival time is “1 ms≦T<3 ms”, and the standard cost is “10”, the CP unit 1130 sets the line cost between the transmission device 1100 and the transmission device 1200 at “60”, and registers this line cost in the second line cost management table explained below.

FIG. 17 is an example of the data structure of the second line cost management table. As shown in FIG. 17, the second line cost management table contains opposing transmission device identification information and second line costs. The opposing transmission device information identifies another transmission device connected opposing to a transmission device. For example, the opposing transmission device identification information of the transmission device 1100 identifies the transmission device 1200 and the transmission device 1300.

In the example of FIG. 17, the second line cost of the path from the transmission device 1100 to a transmission device of the opposing transmission device identification information “10010”, is set at “10”, and the second line cost of the path from the transmission device 1100 to a transmission device of the opposing transmission device identification information “10020”, is set at “60”.

The CP unit 1130 performs OSPF-TE communication, for example, and synchronizes the first line cost and the second line cost with other transmission devices. FIG. 18 is an example of the data structure of a signal used by the transmission device 1100 to synchronize line costs. As shown in FIG. 18, the CP unit 1130 allocates 16 bits to the first line cost, and remaining 16 bits to the second line cost from among 32 bits of the signal length of line cost used for OSPF-TE communication.

The CP unit 1130 performs signal exchange with other transmission devices shown in FIG. 18, and thereby generates the line connection DB for managing the first line cost, and the second line cost between the transmission devices. FIG. 19 is an example of the data structure of the line connection DB 1133. As shown in FIG. 19, the line connection DB 1133 stores therein line identification information, first line costs, second line costs, first transmission device identification information, and second transmission device identification information.

The line identification information identifies paths between transmission devices. The first line cost and the second line cost indicate the costs of the lines identified by the line identification information. The first transmission device identification information and the second transmission device identification information are for identifying transmission devices sandwiching a line identified by line identification information. When the line identified by the line identification information “20010”, is between the transmission device 1000 and the transmission device 1200 for example, the first transmission device identification information identifies the transmission device 1100, and the second transmission device identification information identifies the transmission device 1200.

When the CP unit 1130 transmits data to a destination, the CP unit 1130 obtains a plurality of paths to the destination based on the line connection DB 1133, calculates the line costs of the obtained paths, and also transmits data to the destination through a path having the lowest line cost among the calculated line costs of the paths.

When it is set by a manager that a path is to be selected using the first line cost, the CP unit 1130 obtains a plurality of paths to the destination based on the line connection DB 1133, calculates the first line costs of the obtained paths, and also transmits data to the destination through a path having the lowest first line cost among the calculated line costs of the paths.

When it is set by a manager that a path is to be selected using the second line cost, the CP unit 1130 obtains a plurality of paths to the destination based on the line connection DB 1133, calculates the second line costs of the obtained paths, and also transmits data to the destination through a path having the lowest second line cost among the calculated line costs of the paths.

On the other hand, the CP unit 1130 may determine either to use the first line cost or to use the second line cost based on data to be transmitted. For example, when data to be transmitted is audio data, the second line cost is used to select a path. When data to be transmitted is not audio data, the first line cost is used to select a path.

The CP unit 1130 may select a path using both the first line cost and the second line cost. For example, the CP unit 1130 may calculate the total first line cost and the total second line cost of a path to the destination, and transmit data to-the destination through a path having both the lowest total first line cost, and the lowest total second line cost.

The transmission system according to the third embodiment calculates the first line cost and the second line cost, and selects a path based on a line cost type set in advance. Therefore, the manager can select a path having a lower error rate or a path having a shorter arrival time for data transmission, and perform data transmission in a desired manner.

Of the processes described in the embodiments, all or part of the process described as being performed automatically can be performed manually, or all or part of the process described as being performed manually can be performed automatically with a known method. The process procedures, control procedures, specific names, information including various data and parameters mentioned in the above embodiment can be arbitrarily changed unless otherwise stated.

The constituent elements of the devices shown in the drawings are functionally conceptual, and need not necessarily be physically configured as illustrated. That is, the arrangement of the respective devices is not limited to that shown in the drawings, and can be functionally or physically separated or integrated, partly or wholly, according to the load or usage.

The same function of the respective devices can be entirely or partially realized by a central processing unit (CPU) or a computer program analyzed and executed by CPU. The respective devices can also be implemented in wired-logic hardware.

As set forth hereinabove, according to an embodiment, a plurality of types of line costs, i.e., first and second line costs are calculated, and a path is selected based on the first line cost or the second line cost. Therefore, a manager can select a path having a low error rate or a path having a shorter arrival time for data transmission. Thus, data transmission can be performed as desired by the manager.

Moreover, when data to be transmitted is audio data, the line cost between transmission devices is set based on the second line cost. Therefore, audio data that is more susceptible to an arrival time than to an error rate can be efficiently transmitted to a destination. On the other hand, when data to be transmitted is not audio data, the line cost between transmission devices is set based on the first line cost. Therefore, the data can be efficiently transmitted to a destination.

Furthermore, each transmission device performs data communication with adjacent transmission devices, and calculates the time taken by data to arrive its destination. Based on the calculated time, the transmission device sets the line cost. Thus, it is possible to set the line cost depending on the state of a path that constantly changes over time and select an optimal path as well as to reduce the burden on a manager.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A transmission system that determines a path for data transmission based on line cost set for each line between transmission devices, the transmission system comprising:
an error calculating unit that calculates an error rate of data communicated between the transmission devices; and
a first determining unit that determines first line cost for each line between the transmission devices based on the error rate obtained by the error calculating unit.

2. The transmission system according to claim 1, further comprising:
a time calculating unit that calculates time taken for data transmitted from each of the transmission devices to reach a destination;
a second determining unit that determines second line cost for each line between the transmission devices based on the time obtained by the time calculating unit; and
a setting unit that sets the line cost for each line between the transmission devices based on any one of the first line cost and the second line cost.

3. The transmission system according to claim 2, wherein, when data to be transmitted is audio data, the setting unit sets the line cost based on the second line cost.

4. The transmission system according to claim 2, wherein, when data to be transmitted is not audio data, the setting unit sets the line cost based on the first line cost.

5. A transmission system that determines a path for data transmission based on line cost set for each line between transmission devices, the transmission system comprising:
a time calculating unit that calculates time taken for data transmitted from each of the transmission devices to reach a destination; and
a first determining unit that determines first line cost for each line between the transmission devices based on the time obtained by the time calculating unit.

6. The transmission system according to claim 5, further comprising:
an error calculating unit that calculates an error rate of data communicated between the transmission devices;
a second determining unit that determines second line cost for each line between the transmission devices based on the error rate obtained by the error calculating unit; and
a setting unit that sets the line cost for each line between the transmission devices based on any one of the first line cost and the second line cost.

7. A transmission method applied to a transmission system that determines a path for data transmission based on line cost set for each line between transmission devices, the transmission method comprising:
calculating an error rate of data communicated between the transmission devices;
storing the error rate in the storage device; and
determining first line cost for each line between the transmission devices based on the error rate stored in the storage device.

8. The transmission method according to claim 7, further comprising:
calculating time taken for data transmitted from each of the transmission devices to reach a destination;
determining second line cost for each line between the transmission devices based on the time; and
setting the line cost for each line between the transmission devices based on any one of the first line cost and the second line cost.

9. A transmission method applied to a transmission system that determines a path for data transmission based on line cost set for each line between transmission devices, the transmission method comprising:
calculating time taken for data transmitted from each of the transmission devices to reach a destination;
storing the time in the storage device; and
determining first line cost for each line between the transmission devices based on the time stored in the storage device.

10. The transmission method according to claim 9, further comprising:
calculating an error rate of data communicated between the transmission devices;
determining second line cost for each line between the transmission devices based on the error rate; and
setting the line cost for each line between the transmission devices based on any one of the first line cost and the second line cost.
